(19) United States
(12) Patent Application Publication
(10) Pub. No.: US 2026/0364538 A1
(43) Pub. Date: Nov. 19, 2026

(54) METHOD FOR ATTACHING FIBERS TO A POTTING MOLD FOR A GAS INFUSION MODULE

(71) Applicant: Prosper Technologies, LLC, Miami Beach, FL (US)

(72) Inventor: David Wade Campbell, Fredericton N.B. (CA)

(21) Appl. No.: 19/126,188

(22) PCT Filed: Oct. 16, 2023
(86) PCT No.: PCT/US2023/076987

§ 371 Date: Apr. 30, 2025

Related U.S. Application Data
(60) Provisional application No. 63/382,445, filed on Nov. 4, 2022.

(51) Int. Cl. B01D 63/02; B29C 45/14

(52) U.S. Cl. CPC B01D 63/0221; B01D 63/0224; B01D 63/0233; B29C 45/14385; B29C 45/14426

(57) ABSTRACT

A potting process for a gas infusion module includes cutting one end of a plurality of fibers and wrapping the same around a plurality of cores. The potting process also includes inserting a shell and the plurality of fiber-wrapped cores into an epoxy material and treating the epoxy material to an incubation process to solidify the epoxy material. The solid epoxy material and at least a portion of the fiber-wrapped can be cut to expose the other end of the plurality of fibers. The potting process includes drilling a hole through the solid epoxy and at least one of the plurality of cores therefore exposing an interior portion of the at least one core. The process can also include sealing the fiber-wrapped cores and shell by inserting the fiber-wrapped cores into an additional epoxy material and preserving a gap between the fiber-wrapped cores and the new seal.

### INCORPORATION BY REFERENCE TO ANY PRIORITY APPLICATIONS

This application claims priority to U.S. Provisional Patent Application No. 63/382445, filed Nov. 4, 2022, which is hereby incorporated by reference in its entirety.

### BACKGROUND OF THE INVENTION

### Field of the Invention

The invention is directed to a method of manufacturing a gas infusion module, and more particularly to a method of manufacturing a gas infusion module for use in a gas infusion array.

### Description of the Related Art

Existing methods for making gas infusion systems are complex and inefficient. There is a need for more efficient and cost-effective gas infusion systems and manufacturing methods of components for the same.

### SUMMARY OF THE INVENTION

In accordance with one aspect of the disclosure, a method of manufacturing gas infusion modules is provided, and more particularly to a method of manufacturing gas infusion modules for use in a gas infusion array.

In accordance with another aspect of the disclosure, a method for attaching fibers to a potting mold for a gas infusion module is provided. The method can include cutting open a first end of a plurality of fibers; and wrapping the plurality of fibers around a plurality of cores to create a plurality of fiber-wrapped cores, wherein the plurality of fiber-wrapped cores include a first end, a second end opposite the first end, and a channel extending from the first end to the second end. The method can also include securing the plurality of fiber-wrapped cores to a core spacer by inserting the first end of the plurality of fiber-wrapped cores into a plurality of knobs of the core spacer. The method can also include treating the plurality of fiber-wrapped cores to an epoxy process, the epoxy process can include dipping a shell having a first opening, a second opening, a first end, and a second end, into an injection mold containing an epoxy material so that the second opening and the second end of the shell rest against a base of the injection mold; inserting the second end of the plurality of fiber-wrapped cores through the first opening of the shell and so that the second end of the plurality of fiber-wrapped cores extends into the epoxy material; and treating the epoxy material to an incubation process to solidify the epoxy material about the second end of the plurality of fiber-wrapped cores. The method can also include using a lathe to at least partially remove the solidified epoxy and cut at least a portion of the second end of the plurality of fiber-wrapped cores; and drilling a hole through the solidified epoxy material and across the channel of at least one of the plurality of fiber-wrapped cores. The method can include sealing the second end of the plurality of fiber-wrapped cores by treating the plurality of fiber-wrapped cores to a second epoxy process.

### BRIEF DESCRIPTION OF THE DRAWINGS

FIGS. 1 and 2 show examples of cores for use with a gas infusion module.

FIG. 3. shows examples of a cores and fibers for use with a gas infusion module.

FIG. 4 shows an example of a shell for use with a gas infusion module.

FIGS. 5A-5B show an example of a folded fiber for use with a gas infusion module.

FIG. 5C shows an example of a cut fiber for use with a gas infusion module.

FIGS. 6A-6C show examples of a plurality of fibers wrapped around one or more cores.

FIGS. 7A-7E show the procedure of securing the fiber-wrapped cores to a core spacer.

FIGS. 8A-8G show the procedure of applying an epoxy material to the fiber-wrapped cores and the incubation process.

FIG. 9A shows an example of a device for cutting into the epoxy material.

FIGS. 9B and 9C show examples of a seal crated by the incubation process.

FIG. 10A shows an example of a gas infusion module.

FIGS. 10B and 10C show examples of a connection port and a connection port attached to a core of the gas infusion module respectively.

### DETAILED DESCRIPTION

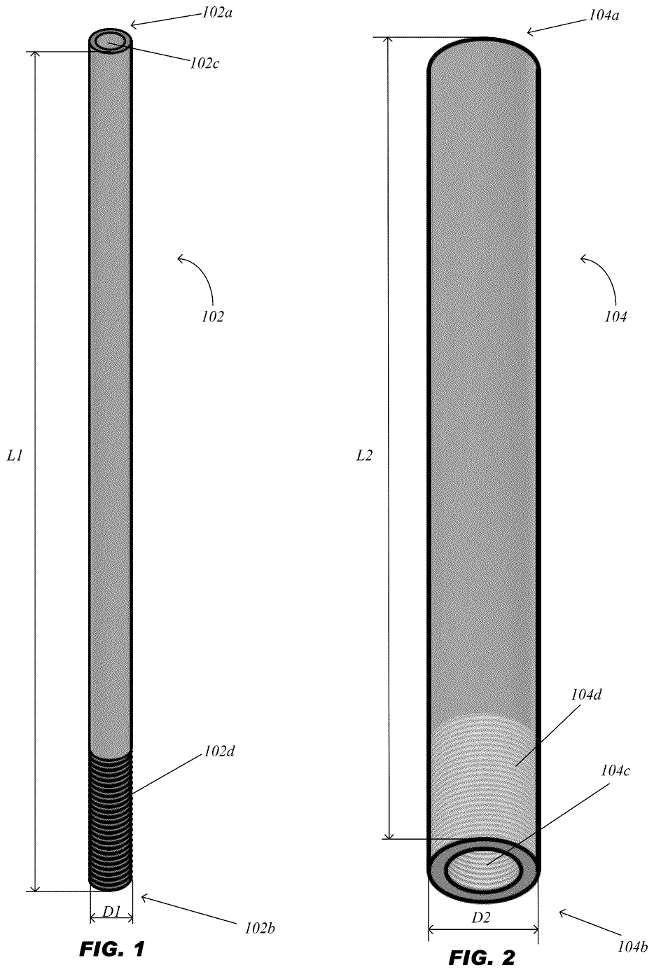

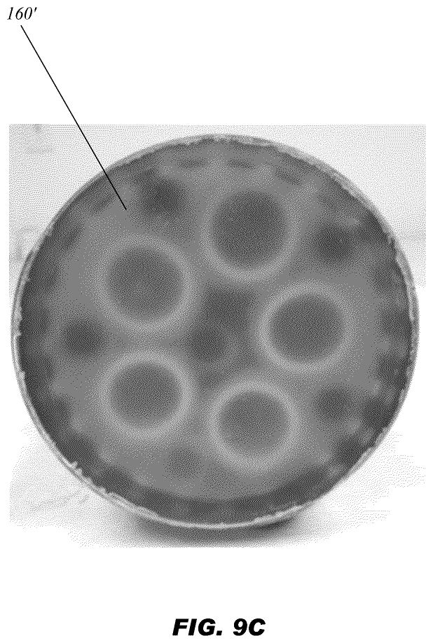

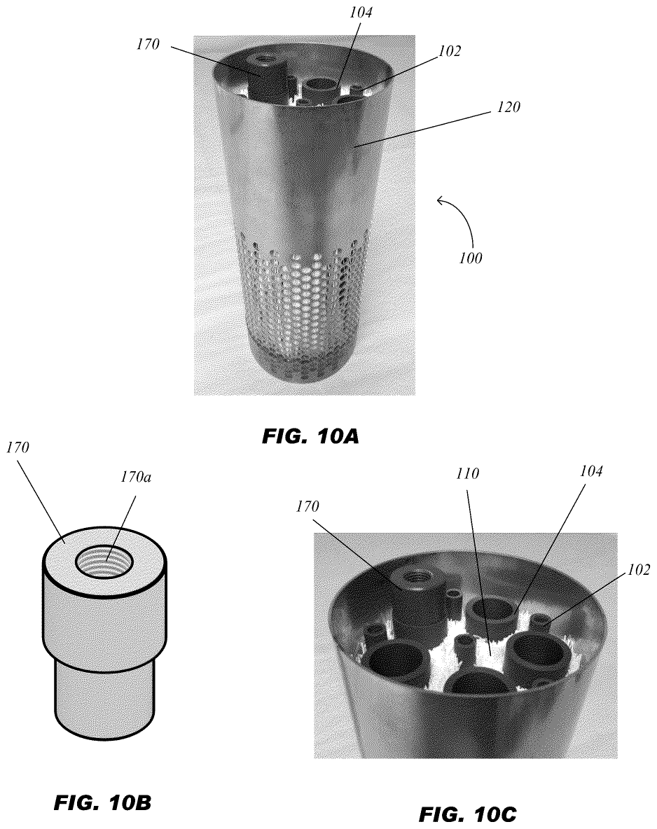

Described herein is a manufacturing method for a gas infusion module 100 (as shown in FIG. 10A). The gas infusion module 100 can have one or more cores 102, 104, as shown in FIGS. 1 and 2, with the cores 104 being larger than the cores 102. In one implementation, the cores 104, 102 are cylindrical or tubes, the core 104 having a larger outer diameter than the core 102. In one example, the gas infusion module can include six cores 102 and five cores 104. However, the gas infusion module can include other combinations of cores 102, 104. In some cases, the cores 102, 104 can include a Polyvinyl chloride (PVC) material; however, the cores 102, 104 can be made of other suitable materials (e.g., other plastics, a metal).

The core 102 can include a first end 102a and a second end 102b opposite the first end 102a. A channel 102c (e.g., bore, central bore) can extend from the first end 102a to the second end 102b (e.g., extend completely through the core 102). The core 102 can optionally include a threated portion 102d extending from the second end 102b and through an exterior portion of the core 102. In some examples, the core 102 has a length L1 of about 9.5 in. and an outer diameter D1 of about ¾ in.

The core 104 can include a first end 104a and a second end 104b opposite the first end 104a. A channel 104c (e.g., bore, central bore) can extend from the first end 104a to the second end 104b (e.g., extend completely through the core 104). The core 104 can optionally include a threated portion 104d extending from the second end 104b and through an interior portion of the core 104. In some examples, the core 104 has a length L2 of about 9.5 in. and an outer diameter D2 of about ⅜ in.

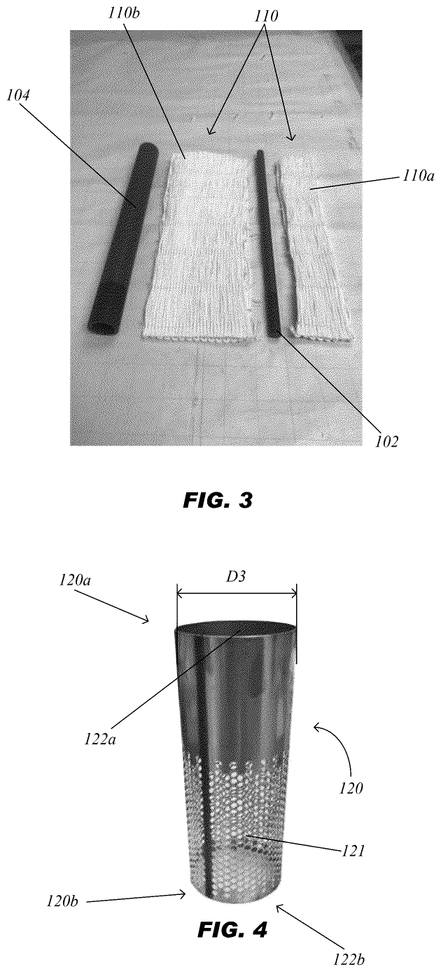

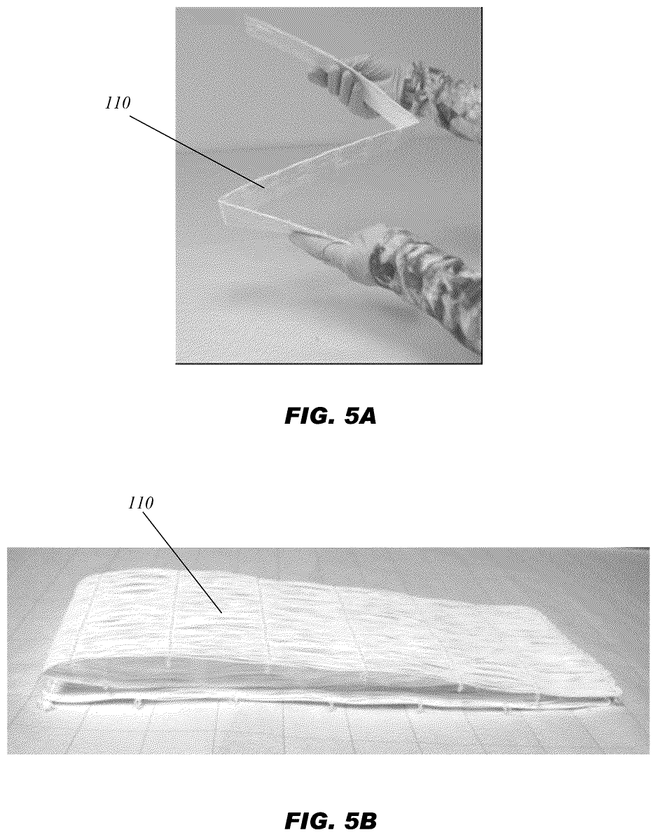

The gas infusion module can also include one or more fibers 110. The fibers 110 can include a micro-porous hollow fiber, as shown in FIG. 3. As further described below, the fibers 110 can be in sheets or layers or bundles that can be wrapped around the cores 102, 104. A first fiber 110a can be wrapped around the core 102 (e.g., about the outer diameter D1 of the core 102) and a second fiber 110b can be wrapped around the core 104 (e.g., about the outer diameter D2 of the core 104). In one example, the first fiber 110a can include a 6×7 tows of fiber and the second fiber 110b can include a 5×14 tows of fiber. The gas infusion module 100 can also include a shell 120, as shown in FIG. 4. The shell 120 can in one example include a stainless-steel material (e.g., 316 stainless steel); however, the shell 120 can be made of other suitable materials (e.g., other suitable metals). The shell 120 can have an outer diameter D3 of about 4 inches, in one example. The shell can also include a first end 120a, a second end 120b, an opening 122a at the first end 120a, and an opening 122b at the second end 120b. In some examples, the shell 120 incudes a plurality of perforations 121 extending between the second end 120b and the first end 120a. In the illustrated implementation, the perforations 121 are on about ½ or less of the length of the shell 120. The perforations 121 extend completely through the wall of the shell 120, allowing flow through the perforations 121 from outside the shell 120 to inside the shell 120. When the fibers 110 are wrapped around the cores 102, 104, the one or more cores 102, 104 can be positioned inside the shell 120, as further discussed below.

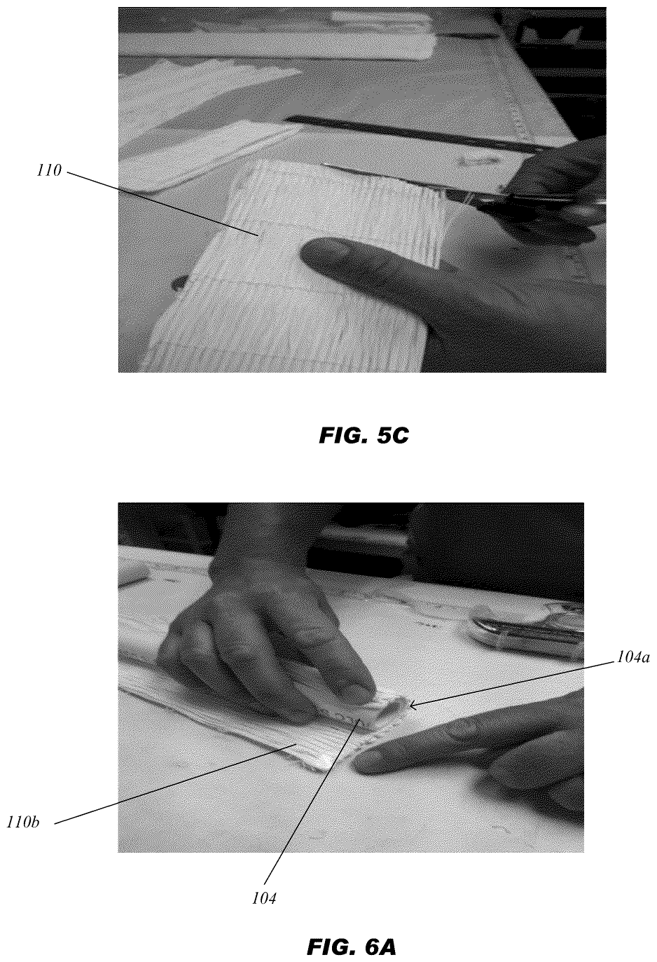

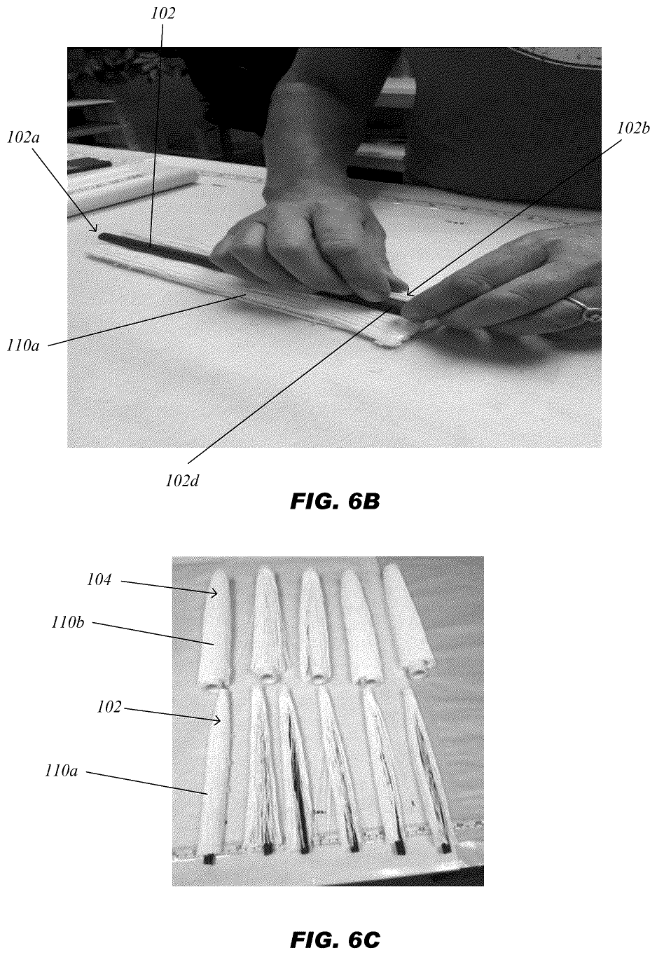

In some cases, the method of manufacturing a gas infusion module 100 includes folding the fibers 110, as shown in FIG. 5A, to increase the tow count of the fibers 110. For example, the first fiber 110a can be folded at twice to increase the tow count of the fiber 110a to 21 tows. Similarly, the second fiber 110b can be folded at least twice to increase its tow count to 42 tows. Once folded, as shown in FIG. 5B, at least one end of the fibers 110 can be cut open, as shown in FIG. 5C. For example, one end of the first and second fibers 110a, 110b can be cut open. In some cases, and as explained further below, the end of the fibers 110 being cut open can be an end not being potted in an epoxy resin, and which allows gas flow (e.g., oxygen flow) through a bore of the fibers 110.

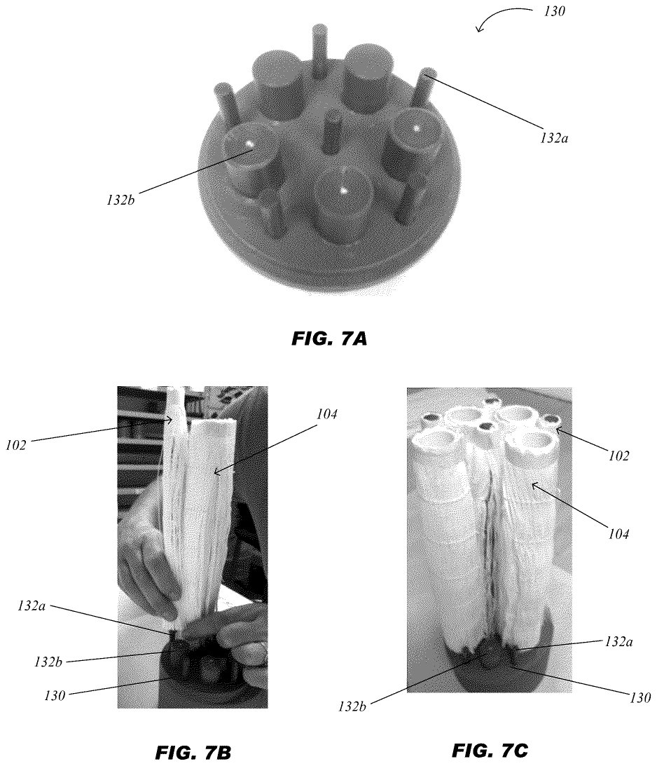

The gas infusion module manufacturing process can also include wrapping the fibers 110 around the cores 102, 104. For example, and as shown in FIG. 6A, the second fiber 110b can be wrapped around the core 104. When wrapped around the second core, the cut-open end of the second fiber 110b can be wrapped around the first end 104a of the core 104 and the other end of the second fiber 110b can be wrapped around the second end 104b of the core 104, as shown in FIG. 6A. Similarly, the cut-open end of the first fiber 110a can be wrapped around the first end 102a of the core 102 and the other end of the first fiber 110a can be wrapped around the second end 102b of the core 102, as shown in FIG. 6B. The fibers 110 can we secured to the fibers 110 by, for example, applying double sided tape (or other adhesive) to both ends of the fibers 110 and securing the fibers 110 to the cores 102, 104 and/or applying double sided tape (or other adhesive) to both ends 102a, 102b, 104a, 104b of the cores 102, 104 and wrapping the fibers 110 around the cores 102, 104. FIG. 6C shows a plurality of fibers 110a, 110b wrapped around the cores 102, 104, respectively.

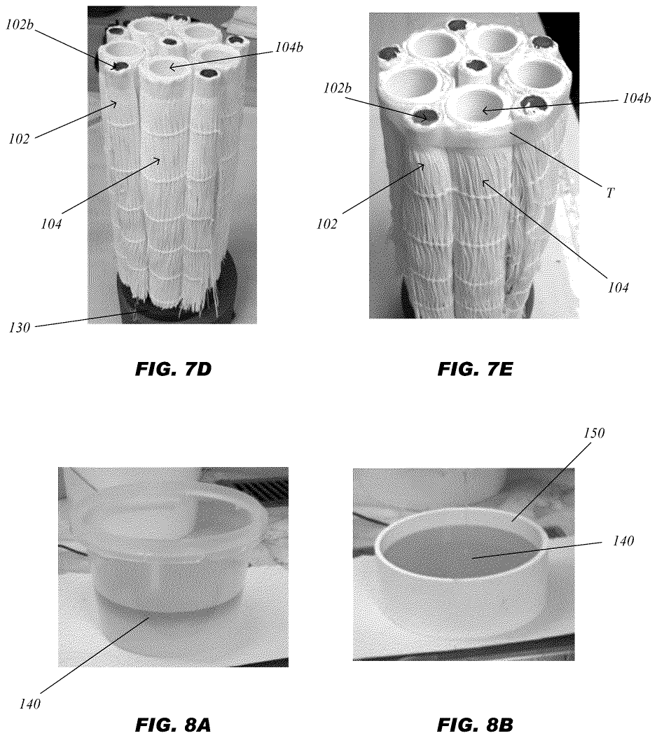

The one or more fiber wrapped cores 102, 104 (shown in FIG. 6C) can be secured to a core spacer 130, shown in FIG. 7A. The core spacer 130 can include a first plurality of knobs 132a and a second plurality of knobs 132b that can receive one or more cores 102, 104, respectively. For example, the first plurality of knobs 132a can have a diameter equal to or less than an inner diameter of the core 102. One end of the core 102, for example the first end 102a, can be positioned on (e.g., over, about) one of the first plurality of knobs 132a thereby securing the core 102 to the core spacer 130. Similarly, the second plurality of knobs 132b can have a diameter equal to or less than an inner diameter of the core 104. One end of the core 104, for example the first end 104a, can be positioned on (e.g., over, about) one of the second plurality of knobs 134b thereby securing the core 104 to the core spacer 130. When the cores 102, 104 are secured to the core spacer 130, at least a portion of the first and second plurality of knobs 132a, 132b extend into the channels 102c, 104c (e.g., bores) of the cores 102, 104.

In some cases, the core spacer 130 can receive and secure multiple cores 102, 104. For example, the first plurality of knobs 132a can include six knobs and the second plurality of knobs 132b can include 5 knobs, thus allowing the core spacer 130 to receive up to six cores 102 and up to five cores 104. As shown in FIG. 7A, the second plurality of knobs 132b can be distributed among the first plurality of knobs 132a. For example, the second plurality of knobs 132b can be arranged circumferentially about a central axis of the core spacer 130, with each of the second plurality of knobs 132b disposed between two of the first plurality of knobs 132a. Additionally, one of the first plurality of knobs 132a can be located generally in the center of the core spacer 130. The core spacer 130 can receive more than or less than six cores 102 and five cores 104 by increasing or decreasing the number of knobs in the first and second plurality of knobs 132a, 132b. FIGS. 7B-7E show a core spacer 130 with different number of cores 102, 104 secured to it. For example, FIG. 7B shows a core spacer 130 with one core 102 and one core 104 and FIG. 7C shows a core spacer with four cores 102 and four cores 104. In some cases, the core spacer shown in FIG. 7A can receive up to 6 cores 102 and up to five cores 104, as shown in FIG. 7D. When secured to the core spacer 130, the cores 102, 104 can be compressed together by, for example, applying tape T around the ends 102a, 102b, 104a, 104b of the cores 102, 104 (as shown in FIG. 7E) and/or around the entire lengths L1, L2 of the cores 102, 104. Beneficially, compressing the cores 102, 104 can prevent the cores 102, 104 from detaching from their respective knobs on the core spacer 130.

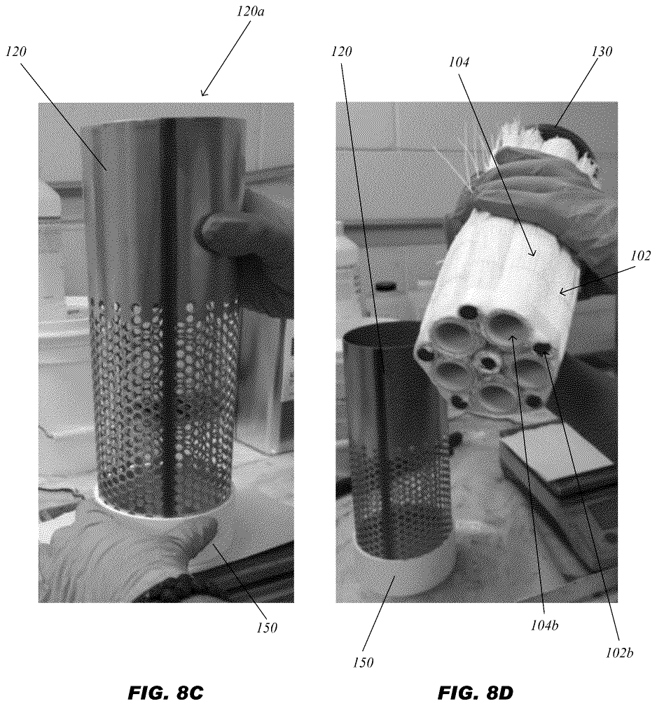

The gas infusion module manufacturing process can also include a potting treatment (e.g., to facilitate or make easier the manufacturing of the gas infusion module 100). The potting treatment can include extending one end of the plurality of cores 102, 104 secured the core spacer 130 in an epoxy material. For example, the epoxy material 140 shown in FIG. 8A can include a mixture of a resin with a hardener. The mixture can in one example have a ratio of about two parts resin and one part hardener. The epoxy material 140 can be poured in a silicone injection mold 150 (as shown in FIG. 8B). After pouring the epoxy material 140 in the injection mold 150, the shell 120 can be inserted in the injection mold 150, as shown in FIG. 8C. In some examples, the second end 120b of the shell 120 is inserted into the epoxy material 140 until the second end 120b rests against a base of the injection mold 150, as shown in FIG. 8C.

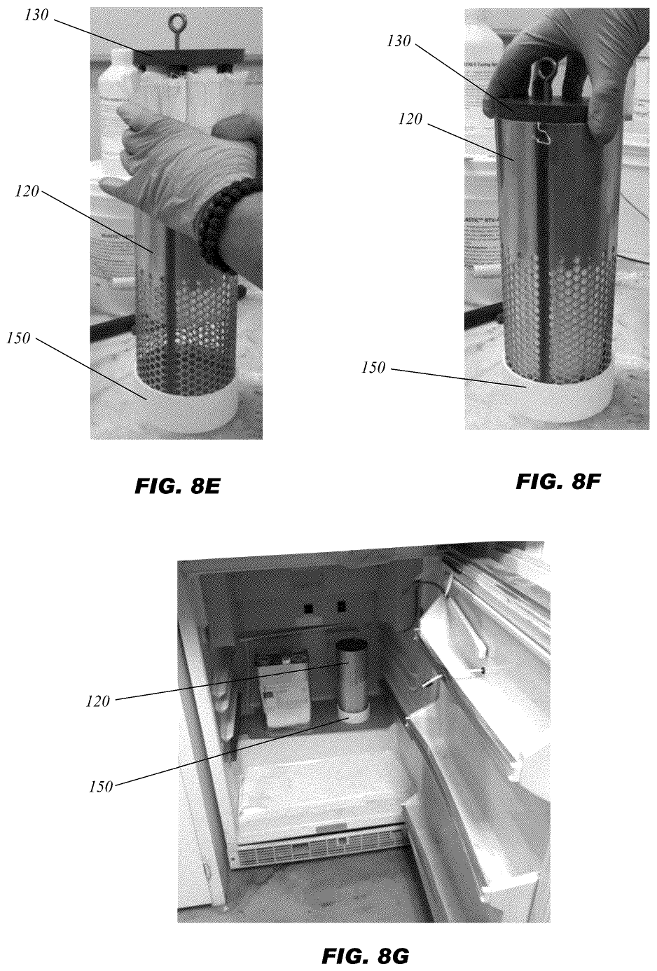

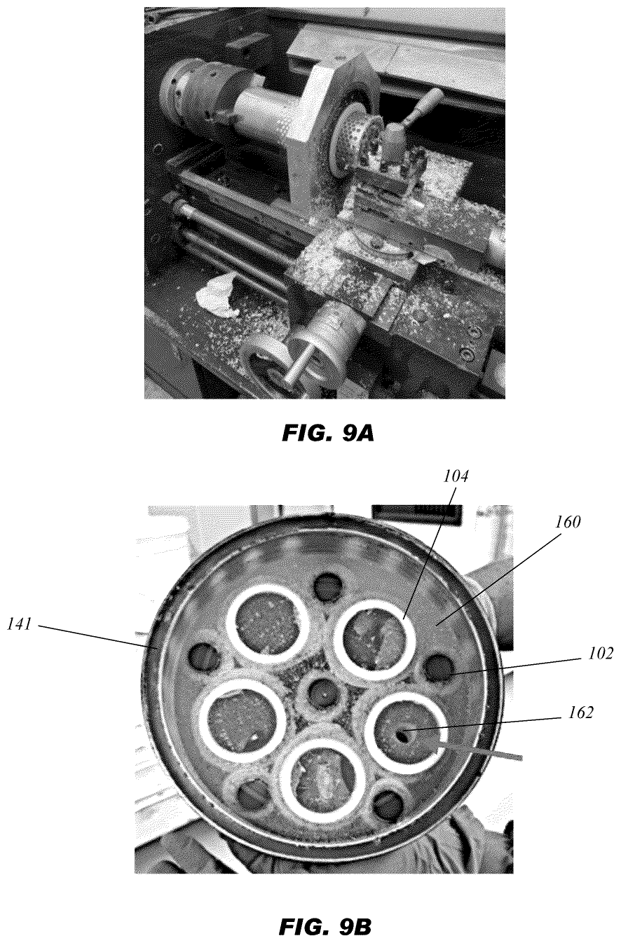

The plurality of cores 102, 104 secured to the core spacer 130 can be inserted through the opening 122a of the shell 120 secured to the injection mold 150. In some examples, the second ends 102b, 104b (e.g., the ends having the uncut fibers 110) of the plurality of cores 102, 104 are inserted through the opening 122 first, as shown in FIGS. 8D and 8E. Once inserted in the shell 120, the plurality of cores 102, 104 can be lowered until the second ends 102b, 104b extends into the epoxy material 140 and rest against the base of the injection mold 150, as shown in FIG. 8F. Resting the second ends 102b, 104b against the bottom of the base of the injection mold 150 exposes at least a portion of the fibers 110a, 110b to the epoxy material. The potting process also includes placing the assembly formed by the shell 120, the plurality of cores 102, 104, the core spacer 130, the injection mold 150, and the epoxy material 140 in an incubator (see FIG. 8G) to cure. In some cases, the incubation includes treating the assembly formed by the shell 120, the plurality of cores 102, 104, the core spacer 130, the injection mold 150, and the epoxy material 140 at or about 30 degrees C for a predetermined period of time, for example, 12 hours, which allows the epoxy material 140 to harden. The incubation can, in some cases, last more than or less than 12 hours. The temperature of the incubator can solidify the epoxy material. Beneficially, the solidified epoxy material 140 can create a seal 160 (as shown in FIG. 9B) along the bottom opening 122b of the shell 120.

At least a portion of the seal 160, the cores 102, 104, and the fibers 110a, 110b can be cut. Before the cutting process, but after the incubation process, the shell 120 can be removed from the injection mold 150. The uncut ends of fibers 110a, 110b on the second ends 102b, 104b of cores 102, 104 can be opened by making a cut parallel to the base of the cores 102, 104. For example, at least a portion of the lengths L1, L2 of the cores 102, 104 can be cut, thereby cutting the uncut ends of the fibers 110a, 110b. In some cases, the cutting process involves cutting into the seal 160 and the fibers 110 a, 110 b by about ½ in. (in a longitudinal direction), which ensures the resulting end of the fibers 110a, 110b are open (e.g., not plugged by epoxy). The cutting process can include using a lathe, as that shown in FIG. 9A, to cut into the seal 160. The lathe can have a chuck having a diameter less than that of the shell 120, thereby cutting into the seal 160 and leaving a layer 161 of epoxy material 140 around an interior wall of the shell 120. The chuck can in one example have a diameter of about 93 mm (3.66 in.). A hole 162 can be drilled through the seal 160 and the channel 104 c of at least one core 104. The hole can be made using a conventional drill and a drill bit having a diameter of about 21/64 in. The hole 162 can provide fluid communication with the channel 104c of the core 104. In some examples, similar holes can be made to the rest of the cores 104.

The cores 102, 104 and the fibers 110a, 110b can be treated to an additional potting process. Ends 102b, 104b of the cores 102, 104 can be extended into an epoxy material identical to or similar to that used during the first potting process. In some cases, however, the additional potting process can include extending the ends 102b, 104b of the cores 102, 104 into the epoxy material but preserving a gap between the seal 160 and the epoxy material. At least a portion of an edge 141 of the seal 160 can contact the epoxy material while preserving a gap between the seal 160 and the epoxy material. The second potting process can also include curing the epoxy material in an incubator. The second potting process can create a seal 160′ identical to or similar to the seal 160, as shown in FIG. 9C.

In some cases, the potting treatment can include treating the second ends 102b, 104b of the plurality of cores 102, 104 with a gel (e.g., which can replace the first potting process described above). For example, the potting process can include dipping the second ends 102b, 104b of the plurality of cores 102, 104 into a gel (e.g., a biopolymer gel) and then into an epoxy material, as described above. The potting process can include cutting open the second ends 102b, 104b of the plurality of cores 102, 104 before dipping the second ends 102b, 104b of the plurality of cores 102, 104 into the gel. The gel can beneficially seal the plurality of fibers 110a, 110b and prevent the epoxy material from clogging the plurality of fibers 110a, 110b. After treating the epoxy material to an incubation process, as described above, the gel can be removed using a gel-dissolving material. Dissolving the gel can beneficially expose the open ends of the plurality of fibers 110a, 110b. The plurality of fibers 110a, 110b can be further cut open by trimming portions of the fibers 110a, 110b extending beyond the solidified epoxy material. A seal, like seal 160′, can be formed by treating the cores 102, 104 and the fibers 110a, 110b to an additional potting process, as described above.

FIG. 10A shows an example of a finished gas infusion module 100 with a connection port 170 attached to the first end 104a of a core 104, FIG. 10B shows the connection portion 170 and FIG. 10C shows a top end of the gas infusion module 100 in FIG. 10A. In some cases, the connection port 170 can include a thread 170a along an interior portion of the connection port 170. The thread 170a can facilitate connection of the connection port to a source of gas (e.g., oxygen). The connection port 170 can be attached to the core 104 including the drilled hole 162. Beneficially, this can allow the gas to flow the entire length L2 of the core 104 thereby oxygenating the fibers 110 of the module 100. For example, the gas can be injected to the infusion module 100 via the connection port 170 and flow the entire length L2 of the core 104 the connection port 170 is attached to. The gas can exit the core 104 via the drilled hole 162 and then flow through the gap between the seals 160, 160′ and continue to flow through the open ends of fibers 110a, 110b. Advantageously, the use of epoxy, as described above, facilitates (e.g., makes easier, simplifies) the manufacturing of the gas infusion module 100.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A method for manufacturing a gas infusion module, comprising:
cutting open a first end of a plurality of fibers;
wrapping the plurality of fibers around a plurality of cores to create a plurality of fiber-wrapped cores; wherein the plurality of fiber-wrapped cores comprise a first end, a second end opposite the first end, and a channel extending from the first end to the second end;
securing the plurality of fiber-wrapped cores to a core spacer by inserting the first end of the plurality of fiber-wrapped cores into a plurality of knobs of the core spacer; and
treating the plurality of fiber-wrapped cores to an epoxy process, the epoxy process comprising:
dipping a shell having a first opening, a second opening, a first end, and a second end, into an injection mold containing an epoxy material so that the second opening and the second end of the shell rests against a base of the injection mold;
inserting the second end of the plurality of fiber-wrapped cores through the first opening of the shell so that the second end of the plurality of fiber-wrapped cores extends into the epoxy material; and
incubating the epoxy material to solidify the epoxy material about the second end of the plurality of fiber-wrapped cores and define a first seal;
at least partially removing the solidified epoxy and cutting at least a portion of the second end of the plurality of fiber-wrapped cores;
drilling a hole through the solidified epoxy material and across the channel of at least one of the plurality of fiber-wrapped cores; and
sealing the second end of the plurality of fiber-wrapped cores by treating the plurality of fiber-wrapped cores to a second epoxy process so as to define a second seal, the second seal spaced from the first seal by a gap.

2. The method of claim 1, further comprising folding the plurality of fibers at least twice.

3. The method of claim 1, wherein wrapping the plurality of fibers around the plurality of cores comprises wrapping the first end of the plurality of fibers around a first end of the plurality of cores.

4. The method of claim 1, wherein securing the plurality of fiber-wrapped cores to the core spacer further comprises applying tape around at least a portion of the fiber-wrapped cores.

5. The method of claim 1, wherein the incubation process comprises heating the epoxy material at about 30 degrees C.

6. The method of claim 1, wherein the epoxy process further comprises mixing a resin and a hardener to create the epoxy material.

7. The method of claim 1, wherein the second epoxy process comprises:
dipping the shell and the plurality of fiber-wrapped cores into the injection mold containing additional epoxy material;
leaving a gap between the fiber wrapped cores and a base of the injection mold; and
treating the additional epoxy material to a second incubation process to solidify the additional epoxy material about the second end of the plurality of fiber-wrapped cores.

8. The method of claim 1, further comprising attaching a connection port to the first end of at least one of the cores of the plurality of fiber-wrapped cores, wherein the connection port facilitates connection to a source of gas.

9. The method of claim 1, wherein the plurality of cores comprises a first plurality of cores and a second plurality of cores, the second plurality of cores having a diameter greater than a diameter of the first plurality of cores.

10. The method of claim 1, wherein wrapping the plurality of fibers around the plurality of cores comprises applying a double-sided tape to the first and second ends of the plurality of fibers and securing the plurality of fibers to the plurality of cores.
